(19) United States
(12) Patent Application Publication
(10) Pub. No.: US 2005/0129427 A1
(43) Pub. Date: Jun. 16, 2005

(54) Rotary member driving mechanism, and image forming apparatus employing this mechanism

(76) Inventors: Yasushi Kinoshita, Hitachinaka (JP); Toru Miyasaka, Tsuchiura (JP); Yuji Uozaki, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/953,538

(22) Filed: Sep. 30, 2004

(30) Foreign Application Priority Data
Dec. 10, 2003 (JP) 2003-411159

(51) Int. Cl. G03G 15/00

(52) U.S. Cl. 399/167

(57) ABSTRACT

For a conventional image forming apparatus, since a waveform in a phase opposite that of a rotation change waveform is applied to a drive motor to rotate a photosensitive member, a correction to cancel the rotation change is also performed for a sudden rotation change of the photosensitive member, or for a high frequency change in the noise component generated by a rotation detector. As a result, since the drive motor can not be smoothly rotated, and since the drive torque of the drive motor is not stabilized, small vibrations always occur in the photosensitive member and cause image deterioration, such as a jitter or banding. Therefore, according to the invention, cycling due to the eccentricity of the photosensitive member is represented by using a continuous repetition function, and the waveform in the opposite phase is employed as a drive instruction value for the driving unit. With this arrangement, smooth rotation of the driving unit can be obtained, and the offsetting of the change is performed.

### BACKGROUND OF THE INVENTION

1. Field of the Invention

The present invention relates to a rotary member driving mechanism that is employed for a color electrophotographic copier, a color printer and an imaging apparatus having an image reader, and that drives rotary members, such as a photosensitive member, a belt drive roller and a document conveying roller, and an image forming apparatus employing this mechanism.

2. Related Background Art

Rotary members, such as a photosensitive drum, a transfer belt and a paper conveying roller, are employed for an electrophotographic copier or printer. For these rotary members, a constant rotation speed must be maintained in order to provide an accurate image exposure position and an accurate color transfer position. However, the rotation speed fluctuates, depending on changes in the rotation speed of a drive motor that turns the rotary member, vibrations caused by eccentricity of the drive shaft, changes in the speed of a rotation transmission system that occur at the portion where gears engage, or changes in speed caused by inherent vibration due to resonance. In order to suppress these changes that affect the rotation speed, generally a method is employed whereby a large heavy flywheel is attached to the rotary member to stabilize the rotation. However, considerable mass is required to obtain a satisfactory rotation performance using the flywheel, and not only is the weight of the apparatus increased, but also a support mechanism is required to hold the apparatus.

Therefore, a technique concerning this type of rotary member driving mechanism is disclosed in JP-A-7-129034, for example. The rotary member driving mechanism employs rotation information, obtained by a rotation detector, to detect rotation changes of a photosensitive member in order to maintain the photosensitive member in a predesignated rotational state. When the rotation state fluctuates, the rotary member driving mechanism calculates a corrected drive value that offsets the change, and reflects the corrected drive value in the rotation of the photosensitive member. Since a corrected drive value in the opposite phase, which offsets the rotation change, is applied for a drive source, the constant rotation state of the photosensitive member can be maintained, while unstable fluctuations are avoided.

Further, in JP-B2-2754582, a method is disclosed for storing, in advance in a storage unit, information for changes in the angular velocity of a drive shaft when a drive motor, for driving a rotary member, is rotated at a predetermined angular velocity, and for reading, from the storage unit, information for the change in the angular velocity, and changing the angular velocity of the drive motor based on the information. According to this method, since the angular velocity of the drive shaft is constant even when the drive system is eccentric, a position shift of an image does not occur in the multiple image transfer, and non-alignment of the transferred images can be suppressed.

However, according to these conventional techniques, since a waveform in the phase opposite that of the waveform causing the rotation change of the rotary member is applied to a drive motor, a corrected value for offsetting the rotation change also affects a sudden change in the rotation of the rotary member, or a high frequency change in a noise element of the rotation detector. Therefore, the drive motor can not be smoothly rotated. Therefore, the drive torque of the drive motor is not stabilized, and small vibrations are always generated that cause image deterioration, such as jitter or banding.

### BRIEF SUMMARY OF THE INVENTION

It is one objective of the present invention to provide a rotary member driving mechanism that resolves the above described problems and prevents a change in a rotation speed, and an image forming apparatus that can perform accurate high-resolution printing.

According to the present invention, cycling due to the eccentricity of a rotary member is represented by a continuous repetition function, and a waveform in the opposite phase is employed as a drive instruction value for a driving unit to obtain smooth rotations and to offset the change in the rotation. Since this control process is especially employed for controlling the rotation of a photosensitive member or the rotation of a transfer member, which is the most important factor in image forming, a high-resolution image can be obtained.

For a rotary member driving mechanism according to the present invention, a smooth drive waveform is obtained by the continuous repetition function, and sudden torque changes do not occur, so that image deterioration, such as jitter or banding, can be suppressed.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWING

FIG. 1 is a diagram showing a rotary member driving mechanism according to a first embodiment of the present invention;

FIG. 2 is a diagram showing a control process performed by the rotary member driving mechanism according to the first embodiment;

FIG. 3 is a diagram showing an example image forming apparatus that has a rotary member driving mechanism according to a second embodiment of the present invention;

FIG. 4 is a graph showing a rotation speed change waveform for a rotary member;

FIG. 5 is a graph showing an integral waveform for the rotary member; and

FIG. 6 is a graph showing a rotation speed change waveform for the rotary member.

### DETAILED DESCRIPTION OF THE INVENTION

The preferred embodiments of the present invention will now be described while referring to the accompanying drawings. The present invention relates especially to the suppression of the cycling of a rotary member that includes a drive source for a photosensitive member and a transfer belt.

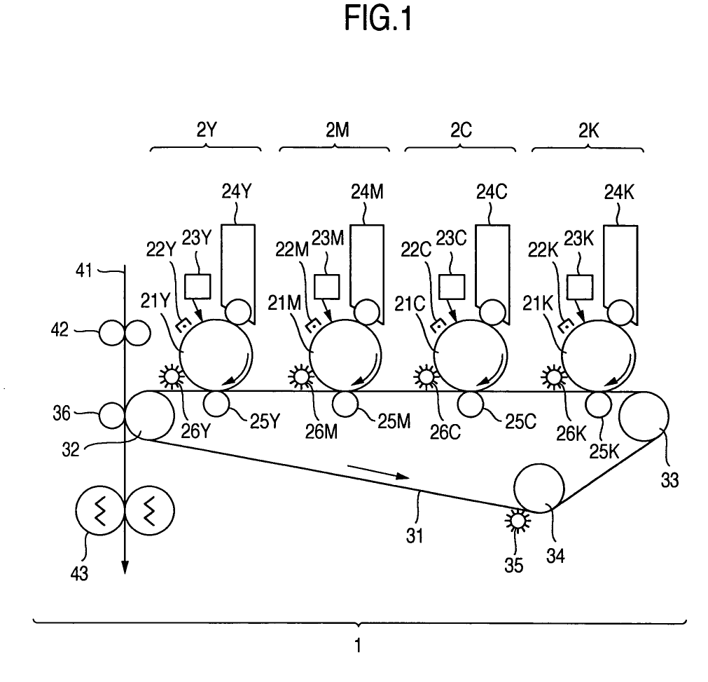

FIG. 1 is a diagram showing the configuration of an image forming apparatus according to the first embodiment of the present invention.

The image forming apparatus 1 shown in FIG. 1 has a configuration for full-color image developing. To form toner images using four colors, four photosensitive members 21Y, 21M, 21C and 21K, which correspond to the four colors, are provided for the image forming apparatus 1. As printing systems 2, charging devices 22Y, 22M, 22C and 22K, exposure devices 23Y, 23M, 23C and 23K, developing devices 24Y, 24M, 24C and 24K, transfer devices 25Y, 25M, 25C and 25K, and cleaning devices 26Y, 26M, 26C and 26K are provided around the individual photosensitive members 21Y, 21M, 21C and 21K. Further, an intermediate transfer belt 31 is positioned to superimpose toner images formed on the photosensitive members 21Y, 21M, 21C and 21K. Arranged inside the transfer belt 31 are a drive roller 32, idlers 33 and 34 and the transfer devices 25Y, 25M, 25C and 25K, which were previously described, while arranged outside the transfer belt 31 are a belt cleaner 35 and a second transfer device 36 positioned opposite the drive roller 32. Also provided are a paper conveying path 41, along which a sheet is conveyed so as to pass through the second transfer device 36, a conveying roller 42 and a fixing device 43.

The printing systems 2 perform the electrophotographic processing for image forming. During the electrophotographic processing, as the photosensitive members 21K, 21M, 21C and 21K are rotated, electrification, exposure, developing, transfer and cleaning are performed in the named order to form a visible image. This processing will be explained by employing a case for the forming of a yellow image. The charging device 22Y generates ions by air discharge that is produced by applying a high voltage to the charging device 22Y. The ions are moved electrically to the surface of the photosensitive member 21Y on which the surface of which electric charges are accumulated. The exposure device 23Y is operated in consonance with a light emission signal, which is generated by a controller (not shown) in accordance with image data, and forms an electrostatic latent image on the surface of the photosensitive member 21Y. The developing device 24Y attaches a color material (yellow toner) to the electrostatic latent image formed on the photosensitive member 21Y, and a visible image is obtained. The transfer device 25Y, then electrostatically transfers the visible image to the intermediate transfer belt 31 where it is held on the surface. After the colored image is transferred to the intermediate transfer belt 31, the cleaning device 26 removes residual color material from the surface of the photosensitive member 21Y, and the image forming process is repeated. The same process is performed for the other colors. Toner images in the individual colors are formed on the corresponding photosensitive members and are transferred to and superimposed on the intermediate transfer belt 31.

In the first embodiment, as is described above, a plurality of printing systems 2 are prepared. The printing systems 2Y, 2M, 2C and 2K perform image forming in parallel, and prepare yellow, magenta, cyan and black visible images. The intermediate transfer belt 31 is extended between the drive roller 32 and the idlers 33 and 34, and is moved by the drive roller 32. And the color images formed by the printing systems 2Y, 2M, 2C and 2K are sequentially transferred to and superimposed on the intermediate transfer belt 31 at contact points with the photosensitive members 21Y, 21M, 21C and 21K. Thereafter, the thus obtained full color image is electrostatically transferred by the second transfer device 36 to a recording sheet that is conveyed along the paper conveying path 41. Then, when the paper sheet bearing the color image is passed through the fixing device 43, the color image is fixed by thermal fusion, and the paper sheet is discharged, outside the apparatus. When an image is formed in the above manner, especially when an electrostatic latent image or a color image is formed on a photosensitive member, the position of the image may be shifted due to the effect rotation change has on the drive shaft. According to the present invention, however, position shift is prevented and a high-resolution image is provided.

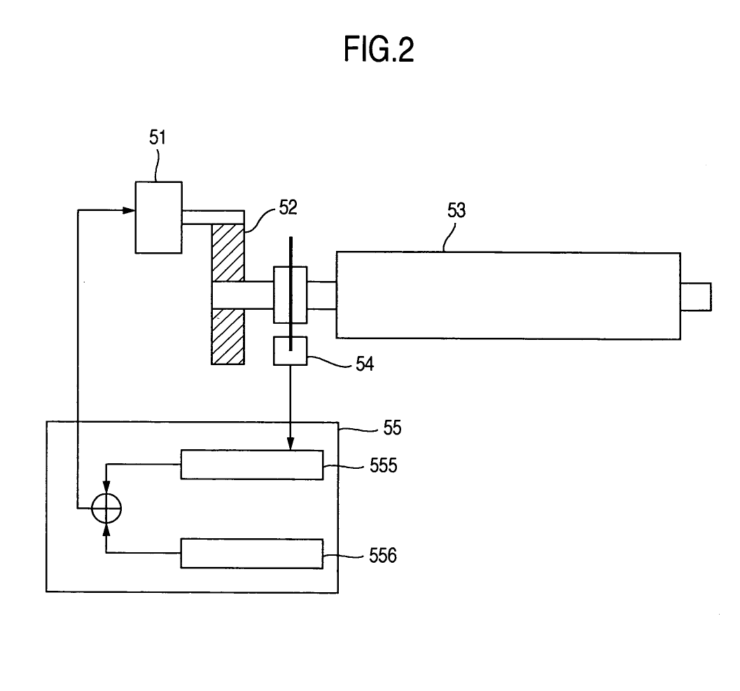

FIG. 2 is a diagram showing an example configuration for a rotary member driving mechanism.

A rotary member driving mechanism 5 comprises: a driving unit 51; a rotation transmission system 52, a rotary member 53, a rotation detector 54 and a controller 55. The controller 55 includes a continuous repetition function table 556, such as an offset waveform table, and a rotation speed instruction value 555.

The driving unit 51 can be constituted by an arbitrary type of motor, such as a pulse motor, like a DC brushless motor or a stepping motor, a DC servo motor or an AC servo motor. It is preferable that a pulse motor be employed because the rotation speed correctly corresponds to a drive pulse, a drive rotation angle and a drive pulse frequency, so that pulse control is easily performed and the rotation speed can be accurately controlled. For example, for a pulse motor that is rotated once at a 60 drive pulse, a drive pulse need only be applied at a frequency of 1500 Hz for a rotation speed of 1500 RPM (rotations per minute) to be accurately obtained. The rotation transmission system 52 is a member, such as a gear or a coupled gear, for transmitting the rotation of the drive unit 51 to the rotary member 53, and it is preferable that the gear ratio be an integral multiple so that the drive unit 51 rotates ten times while the rotary member 53 rotates one time. With the gear ratio of the integral multiple, the rotation speed change is repeated for each cycle of the rotary member 53. With this arrangement, the memory of the offset waveform table used for the rotation speed change can be reduced.

The rotary member 53 is a rotary member such as the photosensitive member 21 or the drive roller 32. One end of the rotary member 53 is connected to the rotation transmission system 52 to obtain rotation force. In order to increase the inertial force of the rotary member 53, a flywheel, having a metal disk shape, may be attached to the shaft of the rotary member 53, or to stabilize the change in the rotation load, an additional function member, such as a load device, may be attached to the shaft of the rotary member 53. The rotation detector 54 is a rotary encoder attached to either the rotary member 53, the rotation transmission system 52 or the driving unit 51. The rotary encoder includes: a code wheel, which is a metal disk in which slits are concentrically formed at like intervals around the outer circumference; and an optical sensor, which detects through the slits the transmission and the blocking of light. It is preferable that the resolution of the code wheel be about 100 pulses for each rotation in order for the amplitude and the phase of the detected speed change waveform to be accurately analyzed. The controller 55 is constituted by a built-in micro computer, a digital signal processor and a special IC. To control the driving unit 51, the controller 55 adds a value from the continuous repetition function table 555 to the rotation speed instruction value 556, and generates a drive pulse for the driving unit 51.

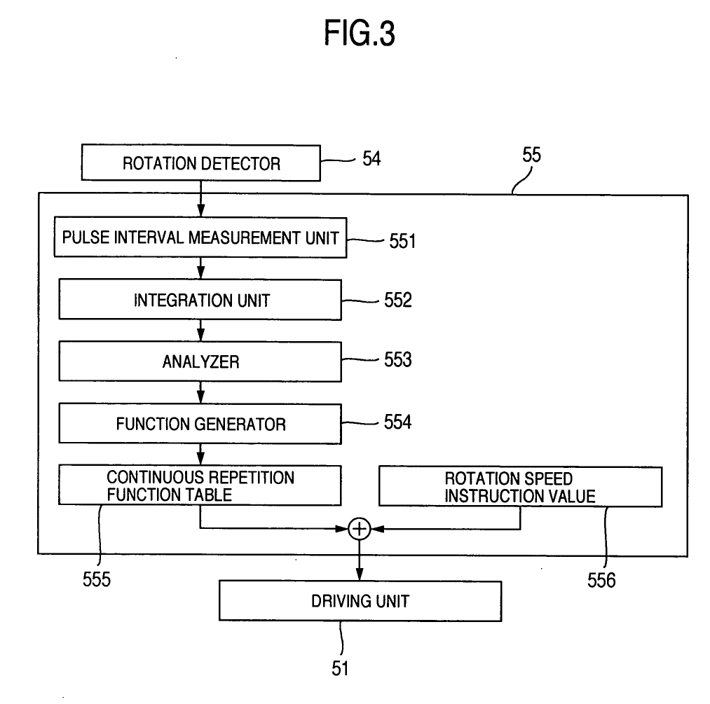

FIG. 3 is a diagram showing the control blocks for a rotary member driving mechanism according to a second embodiment of the invention.

A controller 55 includes: a pulse interval measurement unit 551, an integration unit 552, an analyzer 553, a function generator 554, the continuous repetition function table 555 and the rotation speed instructed value 556.

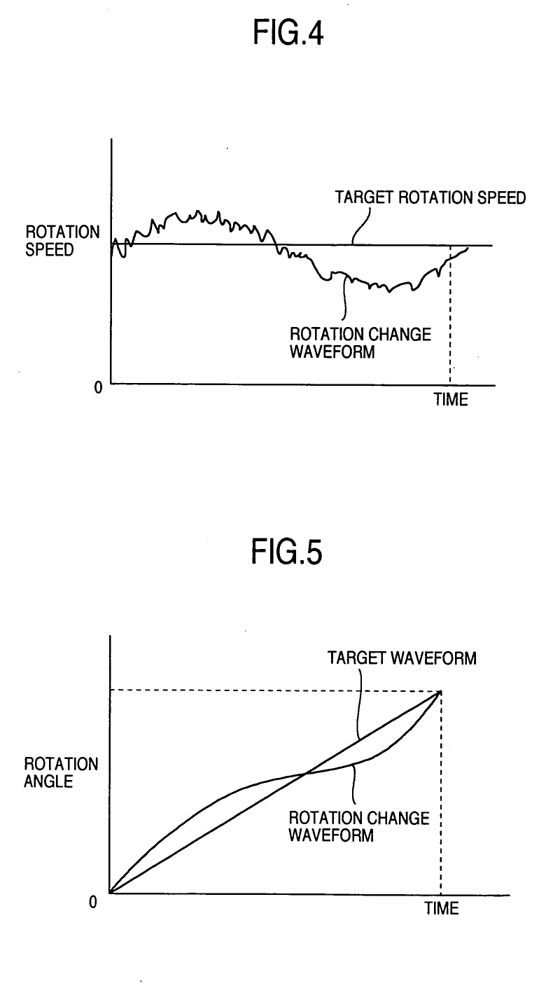

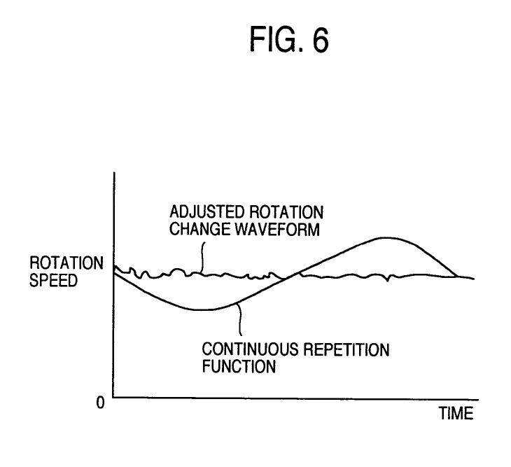

The pulse interval measurement unit 551 measures the interval between pulse signals transmitted by the rotation detector 54. To obtain the interval for the pulse signals, a counter circuit counts the number of reference clocks, which have a considerably higher frequency than the maximum frequency for the pulse signal that is output by the rotation detector 54. Based on a counter value C, a rotation speed Vr (rotations per second) for the rotary member 53 is obtained as Vr=fc/CN, wherein fc denotes the frequency (Hz) of a reference clock, and N denotes the resolution (pulses per rotation) of the rotary encoder. Generally, as is shown in FIG. 4, the rotation waveform is measured while including the noise of a high frequency component. The integration unit 552 accumulates the counter value C, and prepares a table where a slit number n for the rotation detector 54 and the accumulated counter value are correlated with each other. Thus, the rotation change waveform shown in FIG. 5 is obtained. The analyzer 553 compares the rotation change waveform in FIG. 5 with a target waveform, and analyzes the maximum value and the minimum value of a difference and the individual slit numbers. The function generator 554 then employs the maximum value and the minimum value obtained by the analyzer 553 to calculate the amplitude of the continuous repetition function. Furthermore, the function generator 554 employs the slit numbers to calculate a difference between the phases at the base point position of the detected rotation speed change. The continuous repetition function is determined based on the amplitude and the phase difference thus obtained, and a function value is calculated for each interval of the slits, and is written to the continuous repetition function table 555. When the continuous repetition function is a sine function, for example, an amplitude A is represented as A=Πf·(Emax−Emin), wherein Emax denotes the maximum value and Emin denotes the minimum value obtained by the analyzer 553, and f denotes the rotation frequency of the rotary member 53. Further, the maximum slit number value obtained by analyzer 553 is phase difference φ of the sine function. By using the amplitude A and the phase difference φ, the continuous repetition function is represented as Asin(2Π((n−φ)/N)). When 0 to N are provided for the slit numbers n, relative to the continuous repetition function, the values in the continuous repetition function table 555 are calculated. The value in the continuous repetition function table 555 is added to the rotation speed instruction value 556, and the sum is transmitted to the driving unit 51. FIG. 6 is a graph showing a drive waveform on which the continuous repetition function received by the driving unit 51 is superimposed, and the rotation change waveform of the rotary member 53 that is controlled in accordance with the drive waveform. In this manner, the accuracy in the rotation of the rotary member 53 can be improved by using the continuous repetition function having the phase opposite that of the rotation change.

When the process for driving the rotary member 53 is initiated, the rotation speed change of the rotary member 53 is examined for the first rotation, and the controller 55 employs the data for the first rotation to prepare the continuous repetition function table 555. For the second and following rotations, the rotation speed change for the rotary member 53 need not be examined, and data are sequentially read from the continuous repetition function table 555 and are employed for control. For each rotation, the controller 55 returns to the first value in the continuous repetition function table 555 and repetitively employs it. The continuous repetition function table 555 is updated at an arbitrary timing, such as at the activation time, and a phase shift or a time-transient change in the amplitude can be appropriately corrected.

In the image forming apparatus 1, the controller 55 sequentially processes five rotary member driving mechanisms (photosensitive members) 1Y, 1M, 1C, 1K and 1B to update the continuous repetition function table 555. At this time, the individual control blocks can be employed in common, and with this arrangement, the overall processing can be reduced. The process for updating the continuous repetition function table 555 is performed as follows. First, the photosensitive member 1Y is rotated at a predetermined speed, the rotation detector 54Y detects the rotation speed change, and the controller 55 prepares a yellow continuous repetition function table 555Y. Then, the same process is performed for the photosensitive member 1M, and a magenta continuous repetition function table 555M is prepared. The same process is also performed for the photosensitive members 1C, 1K and 1B, and corresponding continuous repetition function tables 555C, 555K and 555B are prepared. For the thus obtained continuous repetition function tables 555, since the phases are aligned at the maximum amplitude value as a starting point, the rotation phases of the four photosensitive members 1Y, 1M, 1C and 1K can be matched, and color alignment can be satisfactorily performed. Further, when the phases of rotary members 2Y, 2M, 2C and 2K are matched with the phase of an intermediate transfer belt 71, the difference in the conveying speed can be reduced.

As is described above, according to the present invention, the rotation speed change component is obtained by removing a high frequency component from the value detected by the rotation detector, and the drive motor is controlled in accordance with a value obtained by adding a normal rotation instruction signal to a component having the phase opposite that of the rotation change element. Therefore, the occurrence of the rotation change can be suppressed for the rotary member rotated by the motor, and accurate rotation control can be performed.

It should be further understood by those skilled in the art that although the foregoing description has been made on embodiments of the invention, the invention is not limited thereto and various changes and modifications may be made without departing from the spirit of the invention and the scope of the appended claims.

1. A rotary member driving mechanism comprising:
a rotary member;
a driving unit for rotating the rotary member; and
a controller for controlling a rotation speed of the driving unit,
wherein the controller adds a predetermined rotation speed instruction value to at least one continuous repetition function value, and controls the rotation speed of the driving unit, so that a predesignated rotation speed is maintained by the rotary member.

2. A rotary member driving mechanism according to claim 1, wherein a rotation frequency used for the continuous repetition function is either a rotation frequency for the rotary member, a rotation frequency for the driving unit, or a rotation frequency for a rotation transmission system that connects the rotary member to the driving unit.

3. A rotary member driving mechanism according to claim 1, wherein the continuous repetition function is either a sine function or an eccentricity removing function.

4. A rotary member driving mechanism according to claim 1, further comprising:
a rotation speed detector for detecting a rotation speed of at least one of the rotary member, the driving unit and the rotation transmission system that connects the rotary member and the driving unit; and
a controller for analyzing a detection speed of the rotation speed detector, and for adjusting a phase and an amplitude for the continuous repetition function.

5. A rotary member driving mechanism according to claim 4, wherein the rotation frequency used for the continuous repetition function is either a rotation frequency for the rotary member, a rotation frequency for the driving unit, or a rotation frequency for a rotation transmission system that connects the rotary member to the driving unit.

6. A rotary member driving mechanism according to claim 4, wherein the continuous repetition function is either a sine function or an eccentricity removing function.

7. An image forming apparatus, for forming an image through an electrophotographic process, comprising:
a printing system including a photosensitive member, a charging device, an exposure device, a developing device, a transfer device and a cleaning device;
a paper conveying path;
a fixing device; and
a controller for controlling a rotation speed of a driving unit that rotates the photosensitive member,
wherein the controller includes a rotary driving mechanism for adding a predesignated rotation speed instruction value to at least one continuous repetition function value, and for controlling a rotation speed of the driving unit, so that a predesignated rotation speed of the photosensitive member is maintained.

8. An image forming apparatus according to claim 7, wherein a rotation frequency used for a continuous repetition function is either a rotation frequency for the photosensitive member, a rotation frequency for the driving unit, or a rotation frequency for a rotation transmission system that connects the photosensitive member to the driving unit.

9. An image forming apparatus according to claim 8, wherein the continuous repetition function is either a sine function or an eccentricity removing function.
